(19) United States
(12) Patent Application Publication
(10) Pub. No.: US 2007/0195995 A1
(43) Pub. Date: Aug. 23, 2007

(54) Calculation of the number of images representing an object

(75) Inventors: Kaori Matsumoto, Shiojiri-shi (JP); Takashige Tanaka, Matsumoto-shi (JP); Hirokazu Kasahara, Okaya-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/707,442

(22) Filed: Feb. 16, 2007

(30) Foreign Application Priority Data
Feb. 21, 2006 (JP) 2006-043828

(51) Int. Cl. G06K 9/00

(52) U.S. Cl. 382/103

(57) ABSTRACT

An image processing apparatus includes a storage unit that stores a plurality of reference feature data items corresponding to a plurality of objects, the reference feature data items respectively representing predetermined features of the objects, a feature data generating unit that, for each of images, generates a feature data item representing each predetermined feature as a predetermined feature of a subject represented in the image, a subject identifying unit that, for each feature data item, identifies to which of the objects the subject corresponds by using the feature data item and the reference feature data items, and a calculation unit that, for each object, depending on a result of identifying by the subject identifying unit, calculates the number of object images in which the object is represented as the subject.

### BACKGROUND

1. Technical Field

The present invention relates to image processing technologies, and in particular, to a technology for calculating, for each of objects, the number of images representing each object as a subject.

2. Related Art

When a plurality of persons are to be photographed, it may be necessary to confirm whether all the persons are photographed during or after photography. For example, when a plurality of students are photographed in a school event, it is necessary to confirm whether all the students have been photographed during photography.

JP-A-2004-38248 is an example of the related art.

However, in an example of the related art, in order to confirm whether all persons have been photographed, it is necessary to sequentially identify persons represented in a plurality of photographed images.

### SUMMARY

An advantage of some aspects of the invention is to provide a technology for easily confirming whether each of objects is represented as a subject in each of images.

To solve at least a part of the problem, an image processing apparatus according to an aspect of the invention includes a storage unit that stores a plurality of reference feature data items corresponding to a plurality of objects, the reference feature data items respectively representing predetermined features of the objects, a feature data generating unit that, for each of images, generates a feature data item representing each predetermined feature as a predetermined feature of a subject represented in the image, a subject identifying unit that, for each feature data item, identifies to which of the objects the subject corresponds by using the feature data item and the reference feature data items, and a calculation unit that, for each object, depending on a result of identifying by the subject identifying unit, calculates the number of object images in which the object is represented as the subject.

In the image processing apparatus, the number of object images representing each object as a subject is calculated. Thus, a user can easily confirm whether the object is represented as a subject.

Preferably, the feature data generating unit generates the feature data item of the subject when the subject satisfies predetermined subject conditions.

As described above, if the feature data item of the subject is generated when the predetermined subject conditions are satisfied, the need to generate an unnecessary feature data item is eliminated and an inappropriate image can be prevented from being subject to counting of object images.

Preferably, for each object, depending on the result of identifying by the subject identifying unit, the calculation unit registers identification information representing an image of the object in a table.

This makes it possible to easily select only each object image representing a particular object as a subject.

For each object, by using a weighting coefficient set for the object, the calculation unit may calculate a first type of index value related to the number of the object images.

For example, when it is expected that the number of object images representing the first object is greater than the number of object images representing the second object, a weighting coefficient for the first object may be set to be less than a weighting coefficient for the second object. This allow the user to easily determine whether the number of object images representing each object is appropriate by confirming a first type of an index value for the object.

In the image processing apparatus, the objects may be persons, and, for each object, by using a weighting coefficient set depending on a face size of the subject, the calculation unit may calculate a second type of index value related to the number of the object images.

For example, when the face of a subject is represented in relatively large size, a relatively large weighting coefficient may be set, and, when the face of the subject is represented in relatively small size, a relatively small weighting coefficient may be set. This allows the user to generally determine whether a face is appropriately represented in an object image representing each object by confirming a second type of index value for each object.

Preferably, the image processing apparatus may include a first notification unit that notifies a user when the number of the object images for each object does not satisfy a condition representing a predetermined number of images.

This can notify the user, for example, when the number of object images representing a first object is excessively greater than the number of object images representing a second object.

The image processing apparatus may further include a reference feature data generator that generates the reference feature data items stored in the storage unit.

The reference feature data generator may include the feature data generating unit and the subject identifying unit, and, when the subject identifying unit is unable to identify the subject by using the feature data item generated by the feature data generating unit and the reference feature data items stored in the storage unit, the reference feature data generator stores the feature data item as one reference feature data item in the storage unit.

This eliminates the need to prepare the reference feature data items.

Preferably, the image processing apparatus further include a second notification unit that notifies a user when the number of the reference feature data items stored in the storage unit is less than the number of the object images.

This ensures that reference feature data items of a plurality of objects can be generated.

After the subject identifying unit calculates a plurality of similarities by using both the feature data item and the reference feature data items, the subject identifying unit selects one of the reference feature data items which corresponds to a maximum similarity among the similarities, and identifies the subject as one of the objects which corresponds to the selected reference feature data item.

The invention can be realized in various forms. For example, the invention can be realized in forms such as an image processing apparatus and method, a computer program for realizing the image processing apparatus and method, a recording medium having the computer program recorded therein, and a data signal including the computer program, which is embodied in a carrier.

### BRIEF DESCRIPTION OF THE DRAWINGS

The invention will be described with reference to the accompanying drawings, wherein like numbers reference like elements.

FIG. 1 is a block diagram illustrating a digital camera according to a first embodiment of the invention.

FIG. 2 is an illustration of the contents of a processing table.

FIG. 3 is a flowchart showing a process for calculating the number of images for each of persons.

FIG. 4 is an illustration of a calculation result screen displayed on a display unit.

FIG. 5 is an illustration of the contents of a processing table in a first modification of the first embodiment.

FIG. 6 is an illustration of a calculation result screen displayed on the display unit in the first modification.

FIG. 7 is a flowchart showing a process for calculating the number of images for each of persons in a second embodiment of the invention.

FIG. 8 is a block diagram showing a personal computer according to a third embodiment of the invention.

FIG. 9 is a flowchart showing a process for calculating the number of images for each of persons in a third embodiment of the invention.

FIG. 10 is an illustration of a calculation result screen displayed on a display unit in the third embodiment.

### DESCRIPTION OF EXEMPLARY EMBODIMENTS

Embodiments of the invention are described below in the following order.

### A. First Embodiment

A-1. Configuration of Image Processing Apparatus

A-2. Generation of Subject Data

A-3. Process for Calculating Number of Pixels

A-4. Modifications of First Embodiment
A-4-1. First Modification
A-4-2. Second Modification;

### B. Second Embodiment; and

### C. Third Embodiment

### A. First Embodiment

### A-1. Configuration of Image Processing Apparatus

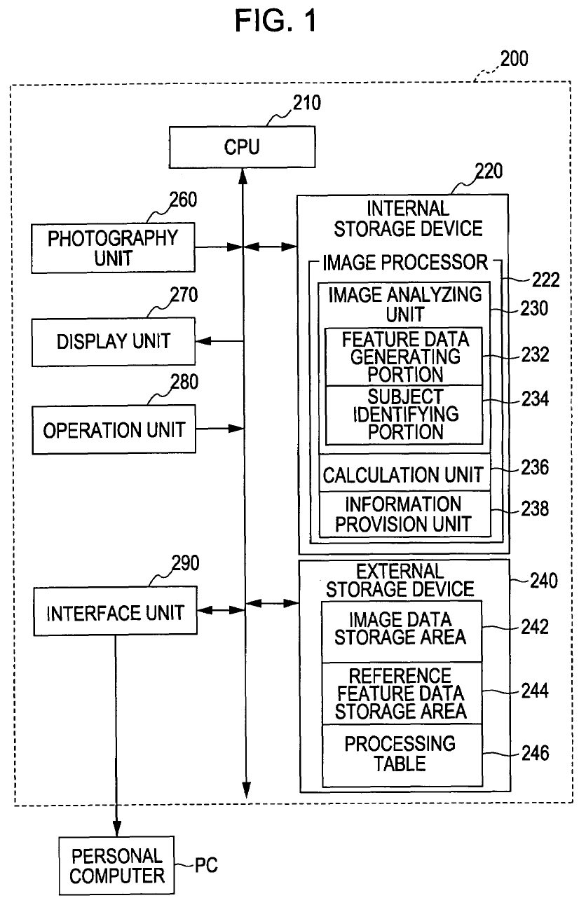

FIG. 1 is a block diagram showing a digital camera 200 according to a first embodiment of the invention.

The camera 200 includes a CPU (central processing unit) 210, an internal storage device 220 including a ROM (read-only memory) and a RAM (random access memory), an external storage device 240 such as a flash memory, a photography unit 260, a display unit 270, an operation unit 280 including buttons, and an interface unit 290. The interface unit 290 performs data communication with externally provided apparatuses of various types. For example, the interface unit 290 provides personal computer PC with image data obtained by photography.

The external storage device 240 includes an image data storage area 242 and a reference feature data storage area 244. The image data storage area 242 stores a plurality of photographed image data items representing a plurality of photographed images generated by photography through a photography unit 260. A reference feature data storage area 244 stores a plurality of reference feature data items corresponding to a plurality of persons. Each reference feature data item represents a feature of the corresponding person, and is generated by performing a feature data generating process (described later) on an image data item for registering that represents the corresponding person. The external storage device 240 also includes a processing table 246 (described later).

The internal storage device 220 (FIG. 1) stores a computer program functioning as an image processor 222. The functions of the image processor 222 are realized such that the CPU 210 executes the computer program. The computer program is provided in a form recorded on a computer-readable recording medium such as a CD-ROM (compact-disc read-only memory).

The image processor 222 includes an image analyzing unit 230, a calculation unit 236, and an information provision unit 238.

The image analyzing unit 230 includes a feature data generating portion 232 and a subject identifying portion 234, and has a function of identifying a subject by analyzing a photographed image data item.

The feature data generating portion 232 analyzes the photographed image data item, and generates feature data of a feature of the subject when a subject represented in a photographed image satisfies predetermined conditions (described later).

In the first embodiment, the feature data includes positional data of the positions of parts (such as two eyes, a nose, and a mouth) on a subject's face, and size data of the sizes of the parts on the subject's face. The feature data is generated by, for example, the following technique. First, a subject's face area represented in a photographed image is extracted. The face area is extracted by detecting a skin color. Next, the face area is enlarged or reduced so as to fall into a rectangular frame having a predetermined size. This standardizes the size of the face area. In the standardized face area, regions of the parts (such as two eyes, a nose, and a mouth) are specified. Each part region is specified by, for example, an edge extracting process and/or a detection process for detecting a region having a specified color. Finally, the positions (coordinates) of the parts on the standardized face area, and the sizes (the numbers of pixels) of the parts are calculated.

The above reference feature data item is generated by performing the feature data generating process on the image data item for registration similarly to the case of the feature data.

By using the feature data generated by the feature data generating portion 232 and the reference feature data items stored in the reference feature data storage area 244, the subject identifying portion 234 identifies to which of registered persons the subject represented in the photographed image corresponds.

For each person, the calculation unit 236 calculates the number of photographed images (hereinafter referred to as “representation images”) in which the person is represented as the subject on the basis of the result of identifying by the subject identifying portion 234. For calculating the number of representation images, the processing table 246 is used.

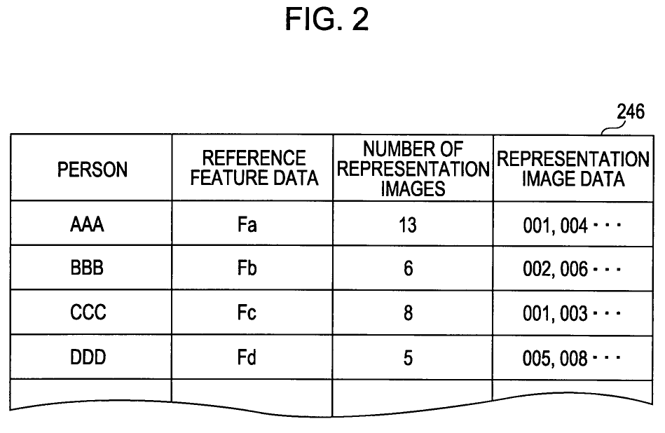

FIG. 2 shows the contents of the processing table 246. As shown in FIG. 2, the processing table 246 includes a “PERSON” column, a “REFERENCE FEATURE DATA” column, a “NUMBER OF REPRESENTATION IMAGES” column, and a “REPRESENTATION IMAGE DATA” column. In the “PERSON” column, a person's name (for example, “AAA”) is registered and the name is set by a user. In the “REFERENCE FEATURE DATA” column, a data name (for example, “Fa”) of a reference feature data item of a corresponding person is registered. In the “NUMBER OF REPRESENTATION IMAGES” column, the number (for example, “13”) of photographed images (representation images) in which the corresponding person is represented as a subject is registered. In the “REPRESENTATION IMAGE DATA” column, data names (for example, “001”, “004”, . . . ) of photographed image data items (representation image data items) used for counting the number of representation images are registered. Instead of the data names, pieces of other identification information (for example, times of generation of corresponding data items) may be registered.

Referring to the processing table 246, the calculation unit 236 increases by one the value of the “number of representation images” corresponding to a “person” identified by the subject identifying portion 234. This calculates the number of representation images in which each person is represented as a subject. The calculation unit 236 also registers data names of photographed image data items in a “representation image data item” corresponding to the “person” identified by the subject identifying portion 234.

The information provision unit 238 displays the result of calculation performed by the calculation unit 236 on the display unit 270. In addition, the information provision unit 238 sends a notification (alert) to the user on the basis of the result of calculation.

### A-2. Generation of Subject Data

As described above, the feature data generating portion 232 analyzes a photographed image data item, and generates a feature data item of a feature of a subject represented in a photographed image when the subject satisfies predetermined conditions (subject conditions). In the first embodiment, as the predetermined conditions, the following conditions are used:

a) First Condition

The size of a face area of a subject represented in the photographed image is equal to or greater than a predetermined size (a predetermined number of pixels).

When the face area of the subject is excessively small, it is difficult to generate a significant feature data item, and, accordingly, the first condition is used; and

b) Second Condition

The ratio of the size of the face area on the subject to the size (the number of pixels) of the photographed image is equal to or greater than a predetermined value (for example, 3%).

When the ratio is less than the predetermined value, it is considered that the subject is represented by chance in the photographed image. Accordingly, the second condition is used.

c) Third Condition

No line, such as a window frame, is represented in the vicinity (i.e., near the neck of the subject) of a lower portion of the face area of the subject represented in the photographed image.

If a line, such as a window frame, is represented in the vicinity of a lower portion of the subject's face area, it looks that the subject's neck is cut. Accordingly, the third condition is used. Detection of the line such as the window frame can be executed by an edge extracting process.

With the above conditions, other conditions may be used. For example, a condition that a photographed image is obtained at an appropriate exposure value and a condition that a photographed image is obtained in an in-focus state may be used.

In addition, employment of appropriate composition by the photographed image may be used as a condition. For example, it is said that, in general, an arrangement in which the subject's face is represented in the center of the photographed image is bad composition. Accordingly, no employment of this arrangement may be used as a condition.

As described above, when a subject represented in the photographed image satisfies the predetermined conditions, the feature data generating portion 232 generates feature data of the subject, whereby unnecessary feature data can be prevented from being generated. In addition, inappropriate photographed images can be prevented from being used for counting the number of representation images. This results in calculating the number of representation images in which each person is appropriately represented.

### A-3. Process for Calculating Number of Pixels

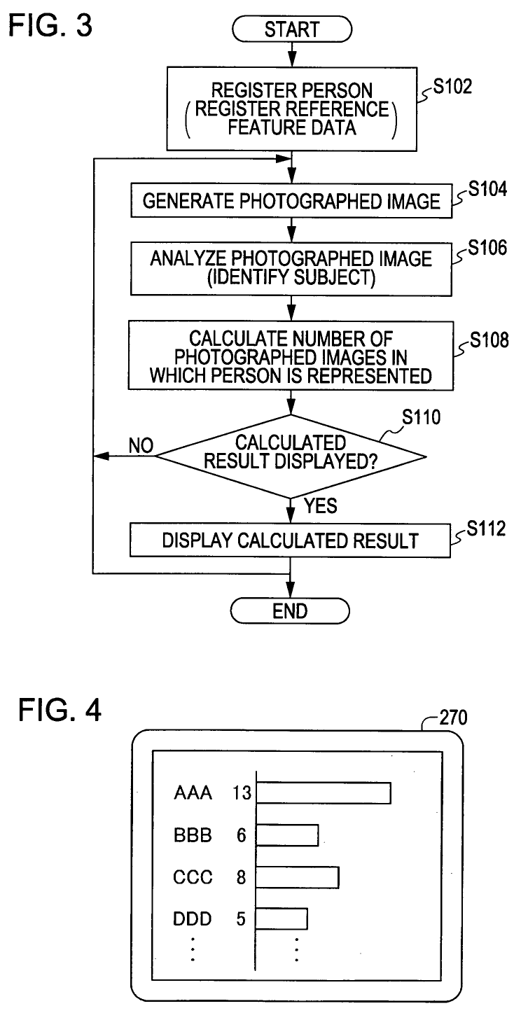

FIG. 3 is a flowchart showing a process for calculating the number of representation images for each person.

In the following description, it is assumed that a plurality of persons travel in a group. In this case, it is necessary to photograph all the persons. By using the camera 200 according to the first embodiment, it can easily be confirmed whether each person has been photographed.

In step S102, the persons, that is, reference feature data items, are registered. Specifically, by operating the operation unit 280, the camera 200 is switched to a registration mode. The persons in the group are sequentially photographed. At this time, the photography unit 260 generates and stores a plurality of registration image data items in the image data storage area 242. The feature data generating portion 232 uses each registration image data item to generate the reference feature data item of each person. The image analyzing unit 230 stores the reference feature data item in the reference feature data storage area 244. The user inputs the name of a person represented by each registration image, while confirming the display unit 270. The image processor 222 registers the names of the persons input by the user and data names of reference feature data items in the “PERSON” and “REFERENCE FEATURE DATA” columns in a form in which both are associated with each other. In step S102, in the “NUMBER OF REPRESENTATION IMAGES” and “REPRESENTATION IMAGE DATA” columns, significant information has not been registered yet.

In the first embodiment, registration image data items are prepared for the persons of the group. However, on one registration image, two or more persons may be represented. In this case, two or more reference feature data items may be generated from one registration image data item.

In step S104, by operating the operation unit 280 the camera 200 can be switched to a photography-and-calculation mode. The user photographs one or more arbitrary persons of the group. In this case, the photography unit 260 generates and stores photographed image data items in the image data storage area 242.

In step S106, the image analyzing unit 230 identifies the subject represented by each photographed image by analyzing each photographed image data item generated in step S104.

Specifically, by analyzing the photographed image data item, the feature data generating portion 232 determines whether the subject represented by the photographed image satisfies the predetermined conditions. If the subject satisfies the predetermined conditions, the feature data generating portion 232 generates a feature data item of features of the subject. When the photographed image represents two or more subjects that satisfy the predetermined conditions, feature data items are generated correspondingly to the subjects.

Next, by using the feature data items and the reference feature data items stored in the reference feature data storage area 244, the subject identifying portion 234 identifies which of the persons registered (in step S102) each person represented by the photographed image is.

Specifically, the subject identifying portion 234 finds a plurality of similarities by using the feature data items and the reference feature data items. In the first embodiment, a similarity is calculated by using angular distance cos θ. Similarity (angular distance cos θ) is calculated by using the following expression:

$$cos θ = \frac{{I}^{->} \cdot {O}^{->}}{\vert {I}^{->} \vert \cdot \vert {O}^{->} \vert}$$

where vector I represents a feature data item for which a similarity is calculated, and vector O represents a reference feature data item.

The subject identifying portion 234 selects a reference feature data item corresponding to the maximum similarity from the similarities. This identifies the subject corresponding to the feature data item as the person corresponding to the selected reference feature data item.

In step S108, on the basis of the result of identification obtained in step S106, for each person, the calculation unit 236 calculates the number of representation images in which the person is represented as a subject. Specifically, the calculation unit 236 increases by one the value of the “NUMBER OF REPRESENTATION IMAGES” in the processing table 246 which corresponds to the person identified in step S106. Accordingly, the number of representation images of the identified person is incremented by one.

In step S108, on the result of identification obtained in step S106, for each person, the calculation unit 236 registers the data names of the representation images in which the person is identified as the subject. Specifically, the calculation unit 236 registers the data names of the photographed image data items (representation image data items) that are obtained in step S104 in a “REPRESENTATION IMAGE DATA” cell corresponding to the person identified in step S106.

In step S108, the value registered in the “NUMBER OF REPRESENTATION IMAGES” cell in the processing table 246 is equal to the number of data names registered in the “REPRESENTATION IMAGE DATA” cell.

In step S110, the image processor 222 determines whether the camera 200 has been instructed by the user to display the result of calculation. If the camera 200 has not been instructed by the user to display the result of calculation, the process returns to step S104, and steps S104 to S108 are repeatedly executed. Whenever the photographed image data item is generated, the number of representation images of each person is sequentially calculated. Alternatively, if the camera 200 has been instructed by the user to display the result of calculation, the process proceeds to step S112.

In step S112, the information provision unit 238 uses the processing table 246 (FIG. 2) to display a calculation result screen on the display unit 270.

FIG. 4 is an illustration of the calculation result screen displayed on the display unit 270. As shown in FIG. 4, for each person, a name (e.g., “AAA”) and the number of representation images (e.g., “13”) are shown on the calculation result screen. In the first embodiment, the number of representation images is indicated by both a numerical value and a bar graph.

By confirming the calculation result screen, the user can easily confirm whether all the persons have been photographed. Also, the user can easily confirm whether the number of representation images of the person is biased. On the basis of the calculation result, the user can reconsider further photography. For example, as shown in FIG. 4, the number of representation images of the person “BBB” and the number of representation images of the person “DDD” are relatively small. Accordingly, the user can continue photography so that the numbers of representation images of each person are equal.

As described above, the user can send a notification (alert) to the user on the basis of the calculation result. Specifically, the information provision unit 238 notifies the user when the number of representation images for each person does not satisfy a predetermined condition (condition concerning the number of representation images). As the predetermined conditions, for example, a condition that a value obtained by dividing the maximum value of the numbers of representation images by the minimum value of the numbers of representation images is equal to or less than a predetermined value (for example, 1.5), and a condition that a difference between the maximum value of the numbers of representation images and the minimum value of the numbers of representation images is equal to or less than a predetermined value (for example, 5) can be used. In this manner, for example, when the number of representation images in which a first object is represented is excessively greater than that of representation images in which a second object is represented, the information provision unit 238 can notify the user. The notification (alert) may be performed such that the information provision unit 238 displays an alert on the display unit 270. In addition, the notification may be performed by generating alert sound from a speaker (not shown). This manner of notification allows the user to reconsider further photography by confirming the calculation result screen.

As described above, in the first embodiment, depending on the result of identifying subjects in photographed images, for each person, the number of representation images in which the person is represented as a subject is calculated. Thus, the user can easily confirm whether the person is represented as a subject.

In the first embodiment, in the “REPRESENTATION IMAGE DATA” column of the processing table 246, data names of photographed image data items (representation images), which are used for counting the numbers of representation images, are registered. Accordingly, by selecting a particular person, the user can selectively display, on the display unit 270, only representation images in which the particular person is represented as a subject.

### A-4. Modifications of First Embodiment

### A-4-1. First Modification

In the first embodiment, it is not considered whether the particular person is mainly represented in the photographed images. Accordingly, this can generate a case in which, although the number of representation images of the particular person is approximately equal to the number of representation images of a different person, the number of photographed images in which the particular person is mainly represented is excessively less than the number of photographed images in which the different persons is mainly represented.

Accordingly, a first modification of the embodiment is designed so that, with the number of representation images of each person, the number of photographed images (hereinafter referred to as “portrait images”) in which the person is mainly represented can be calculated.

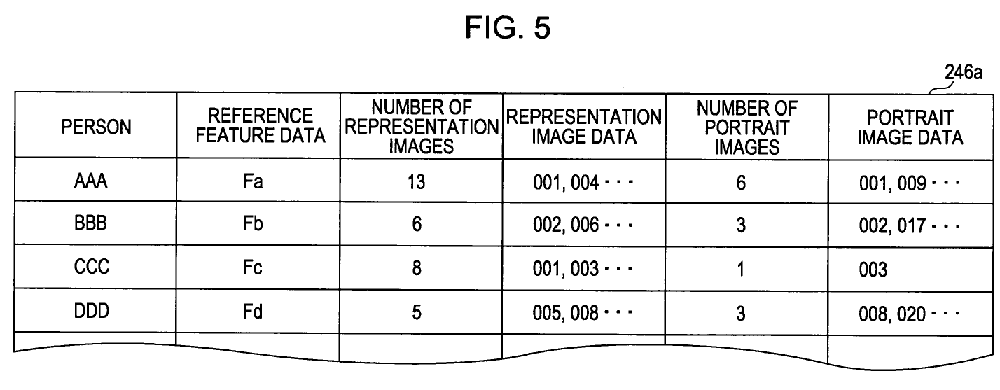

FIG. 5 is an illustration of the contents of a processing table 246a. Comparison with FIG. 2 indicates that, in the processing table 246a in FIG. 5, a “NUMBER OF PORTRAIT IMAGES” column and a “PORTRAIT IMAGE DATA ” column are added. In the “NUMBER OF PORTRAIT IMAGES” column, the number of (for example, “6”) photographed images (portrait images) in which a corresponding person is mainly represented as a subject is registered. In the “PORTRAIT IMAGE DATA” column, data names (for example, “001”, “009”, . . . ) of photographed image data items (portrait image data items), which are used for the number of portrait images, are registered.

In the first modification, similarly to the first embodiment, the process shown in FIG. 3 is executed.

Steps S102 and S104 in FIG. 3 in the first modification are identical to those in the first embodiment.

In step S106 in FIG. 3, the image analyzing unit 230 further analyzes whether a subject's face is mainly represented in each photographed image. Specifically, when the ratio of the size (the number of pixels) of the face area of the subject to the size (the number of pixels) of the photographed image data item is equal to or greater than a predetermined value (for example, 12%), the image analyzing unit 230 determines that the photographed image is a portrait image of a person corresponding to the subject.

In step S108 in FIG. 3, on the basis of identification result and determination result obtained in step S106, for each person, the calculation unit 236 further calculates the number of portrait images in which the person is mainly represented as a subject. Specifically, if, in step S106, it is determined that the photographed image is a portrait image, the calculation unit 236 increases by one a value of the “NUMBER OF PORTRAIT IMAGES” in the processing table 246a, the value corresponding to the person identified in step S106.

Portrait images are subject to counting of the number of representation images. Accordingly, the number of portrait images of each person is less than the number of representation images of the corresponding person.

In addition, on the result of identification and result of determination obtained in step S106, for each person, the calculation unit 236 registers data names of portrait image data items in which the person is mainly represented as a subject. Specifically, if, in step S106, it is determined that the photographed image is the portrait image, the calculation unit 236 registers the data names of the photographed image data items obtained in step S104 in a “PORTRAIT IMAGE DATA” cell of the processing table 246a which corresponds to the person identified in step S106.

Step S112 in FIG. 3 in the first modification is identical to that in the first embodiment. However, the calculation result screen displayed on the display unit 270 is altered.

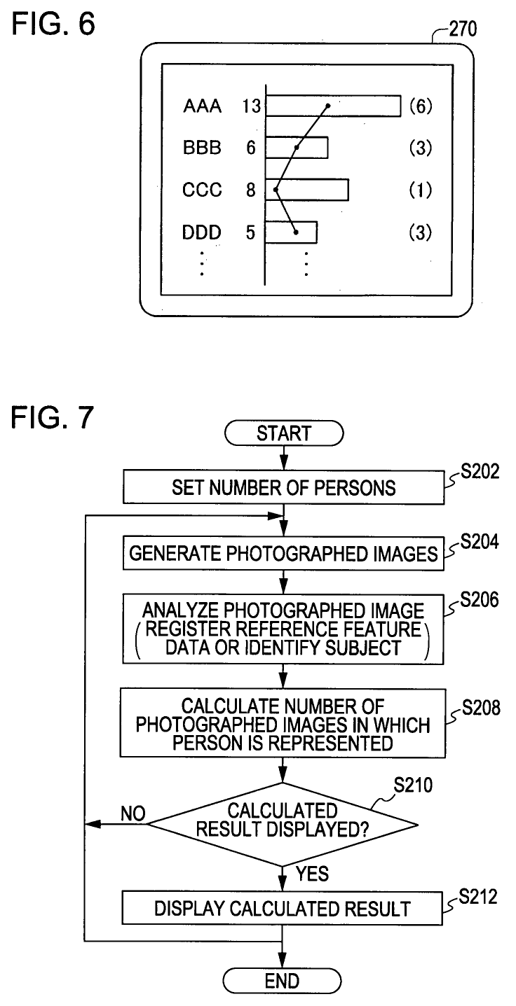

FIG. 6 is an illustration of the calculation result screen displayed on the display unit 270 in the first modification. Comparison with FIG. 4 indicates that the calculation result screen further shows the number of portrait images for each person. In the first modification, the numbers of portrait images are indicated by both parenthesized numerical values and a line graph.

As described above, by simultaneously displaying the numbers of representation images and the numbers of portrait images, the user can easily confirm whether all the persons have been photographed and can easily confirm whether all the persons have mainly been photographed. In addition, the user can easily confirm whether the number of representation images of each person is not biased, and can easily confirm whether the number of portrait images of each person is not biased. The user can reconsider further photography on the basis of the result of calculation. For example, as shown in FIG. 6, the ratio of the number of portrait images of the person “CCC” to the number of representation images is relatively small. Accordingly, the user can continue photography so that the ratio of the number of portrait images of each person to the number of representation images is equal.

In the first modification, in the “PORTRAIT IMAGE DATA” column of the processing table 246a, the data names of photographed image data items (portrait image data items), which are subject to counting of the numbers of portrait images, are registered. Accordingly, by selecting a particular person, the user can selectively display, on the display unit 270, only portrait images in which the particular person is represented as a subject.

### A-A-2. Second Modification

In the first embodiment, the calculation unit 236 calculates an actual number of representation images in which each person is represented as a subject, and displays the actual number as a result of calculation. Unlike the first embodiment, in the second modification, the calculation unit 236 calculates an index value different from the actual number by setting a weighting coefficient, and displays the index value as a result of calculation. Since the index value is not the actual number, it is preferable to display the index value as only a graph such as the bar graph (FIG. 4).

For example, it may be requested that the number of representation images of a first person (for example, a child) be greater than the number of representation images of a second person (for example, a parent). In this case, when actual numbers of representation images of the persons are displayed, the actual numbers have large variation, so that it is difficult for the user to determine whether the actual number of representation images of each person is appropriate.

In this case, weighting coefficients may be set in units of objects. For example, for the first person (child), a first weighting coefficient (e.g., 0.3) may be set, and, for the second person (parent), a second weighting coefficient (e.g., 1.0) may be set. The calculation unit 236 calculates a first index value by multiplying the number of representation images of the first person by the first weighting coefficient, and calculates a second index value by multiplexing the number of representation images of the second person by the second weighting coefficient. In this manner, when it is requested that the number of representation images of the first person be greater than the number of representation images of the second person, by confirming the index value for each person, the user can easily determine whether the actual number of representation images of the person is appropriate. The user can also perform photography so that the index values, displayed on the calculation result screen, of representation images of the persons are equal.

A weighting coefficient may be set depending on the size (the number of pixels) of the face of the subject represented in the representation image, specifically, depending on the ratio (face area ratio) of the size (the number of pixels) of the face area to the size (the number of pixels) of the representation image. For example, when the face area ratio is greater than a first threshold value, a first weighting coefficient (e.g., 1.5) may be set. When the face area ratio is less than a second threshold value, a second weighting coefficient (e.g., 0.5) may be set. When the face area ratio is not greater than the first threshold value and not less than the second threshold value, a third weighting coefficient (e.g., 1.0) may be set. At this time, the calculation unit 236 calculates a first index value by multiplying the number of representation images, in which the face area ratio is greater than the first threshold value, by the first character vector. The calculation unit 236 calculates a second index value by multiplying the number of representation images, in which the face area ratio is less than the second threshold value, by the second weighting coefficient. The calculation unit 236 calculates a third index value by multiplying the number of representation images, in which the face area ratio is not greater than the first threshold value and not less than the second threshold value, by the third weighting coefficient. Accordingly, by confirming the index value for each person, the user can generally determine whether the value is appropriately represented in the representation image of the person. In addition, when the index value for a particular person is small, the user can perform photography so that the face area of the particular person has a large ratio.

Normally, the face of a child is represented larger than the face of an adult. Accordingly, for each of representation images of the child and the adult, a weighting coefficient that is set depending on the ratio of the face area ratio may be changed. As is well known, the face of the child has relatively lower eyes, and the face of the adult has relatively upper eyes. By using these features, the weighting coefficient can be dynamically changed depending on the subject and the face area ratio of the subject.

The second modification can be used in combination of the first modification.

### B. Second Embodiment

In the first embodiment, in step S102 (FIG. 3), a plurality of persons of a group are registered by using registration image data items. Unlike the first embodiment, a second embodiment of the invention is designed so that the persons of the group can be registered without using registration image data items.

FIG. 7 is a flowchart showing a process in the second embodiment for calculating the number of representation images for each person.

In step S202, the number of persons is registered. Specifically, by operating the operation unit 280, the user sets the number of persons of a group. At this time, depending on the number of persons set by the user, the image processor 222 generates a processing table 246′ (not shown) similar to the processing table 246. However, in step S202, the names of the persons are not set by the user. Accordingly, in the second embodiment, in a “PERSON” column of the processing table 246′, identification numbers that identify the persons are registered. In addition, in step S202, reference feature data items have not been created yet. Accordingly, in step S202, in the “REFERENCE FEATURE DATA”, “NUMBER OF REPRESENTATION IMAGES”, and “REPRESENTATION IMAGE DATA” columns, pieces of significant information have not been registered yet.

In step S204, similarly to step S104 (FIG. 3) in the first embodiment, photographed image data items are generated.

In step S206, similarly to step S106 (FIG. 3) in the first embodiment, the image analyzing unit 230 identifies the subject represented in the photographed image by analyzing the photographed image data item.

Specifically, by analyzing the photographed image data item, the feature data generating portion 232 generates a feature data item of the subject when the subject represented in the photographed image satisfies the predetermined conditions.

Next, the subject identifying portion 234 calculates one or more similarities by using the feature data item and the one or more reference feature data items stored in the reference feature data storage area 244. In the second embodiment, in step S202, the reference feature data items have not been prepared yet. Accordingly, in the second embodiment, the subject is identified, while generating the reference feature data items.

Specifically, when the similarities are calculated by using a reference feature data item initially generated from the photographed image data item, the reference feature data storage area 244 stores not reference feature data item. Accordingly, the subject identifying portion 234 cannot calculates the similarities. In this case, the image analyzing unit 230 stores the feature data item generated by the feature data generating portion 232 as the reference feature data item in the reference feature data storage area 244.

When similarities are calculated by using a second and subsequent feature data items generated from the photographed image data items, the reference feature data storage area 244 stores one or more reference feature data items. Accordingly, the subject identifying portion 234 can calculate one or more similarities by using the feature data item and each of the one or more reference feature data items. However, when the maximum similarity of the one or more similarities is less than a predetermined threshold value, that is, when a reference feature data item similar to the feature data item does not exist, the subject identifying portion 234 cannot identify the subject. Therefore, the image analyzing unit 230 stores the feature data item generated by the feature data generating portion 232 as the reference feature data item in the reference feature data storage area 244. Alternatively, when the maximum similarity of the one or more similarities is not less than the predetermined value, the subject identifying portion 234 selects a reference feature data item corresponding to the maximum similarity. This allows the subject corresponding to the feature data item to be identified as a person corresponding to the selected reference feature data item.

In the second embodiment, when the feature data item is registered as the reference feature data item, the image analyzing unit 230 displays, on the display unit 270, the subject corresponding to the feature data item, and queries the user about whether to register the feature data item. When the subject displayed on the display unit 270 is a person to be registered, the user permits registration. This prevents registration of a feature data item of an unrelated person who is not to be registered.

In steps S208 and S210, processing similar to that in steps S108 and S110 (FIG. 3) in the first embodiment is executed.

In step S212, processing similar to that in step S112 (FIG. 3) in the first embodiment is executed. However, since, in the second embodiment, the name of each person is not registered, in step S212, on the calculation result screen (FIG. 4) displayed on the display unit 270 displayed in step S212, an identification number and the number of representation images are shown for each person.

In the second embodiment, similarly to the first embodiment, the information provision unit 238 sends a notification (alert) to the user on the basis of the result of calculation. In particular, in the second embodiment, only the number of persons is registered. Thus, the information provision unit 238 sends the notification (alert) to the user when the number of reference feature data items stored in the reference feature data storage area 244 is less than the number of persons. This ensures that reference feature data items of all the person of the group can be generated.

As described above, also in the second embodiment, similarly to the first embodiment, in response to the result of identifying each subject represented in the photographed image, for each person, the number of representation images in which each person is represented as the subject is calculated. Thus, the user can easily confirm whether the person is represented as a subject.

In particular, when the second embodiment is employed, compared with the case of employing the first embodiment, the user only needs to register the number of persons, and does not need to photograph registration images in order to prepare a plurality of reference feature data items. It is preferable that the second embodiment be employed, for example, in a case in which persons other than a person to be photographed do not appear in a place for photography. Examples of the place include, for example, a closed space such as a bridal party site or a classroom of a school.

Since, in the first embodiment, the names of persons to be photographed are registered beforehand, even if the number of representation images of a particular person is zero, the user can immediately know who the particular person is. Unlike the first embodiment, since, in the second embodiment, the names of the persons to be photographed are not registered, when the number of representation images of a particular person is zero, the user cannot immediately know who the particular person is. However, the user can estimate the particular person by confirming representation images of other persons.

Also in the second embodiment, the first and second modifications of the first embodiment are applicable.

### C. Third Embodiment

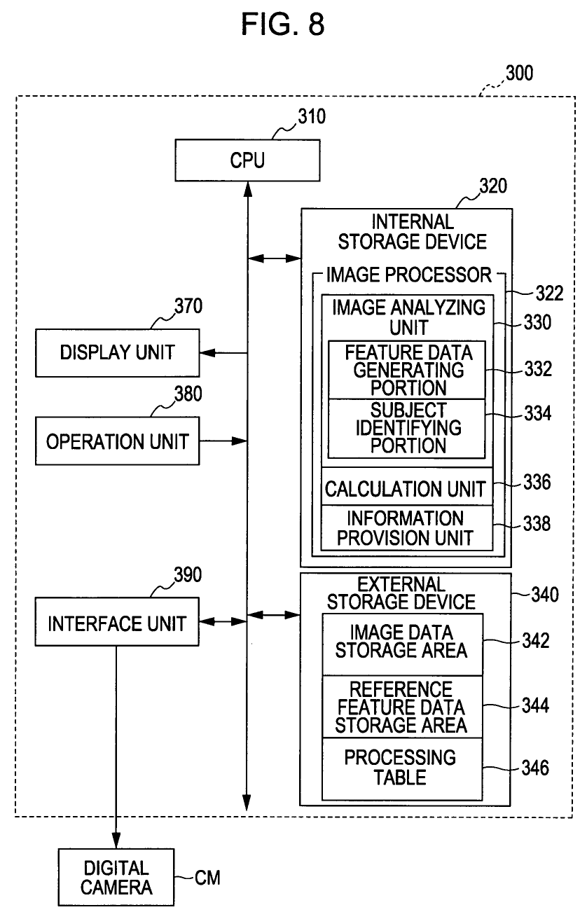

FIG. 8 is a block diagram showing a personal computer 300 according to a third embodiment of the invention.

Similarly to the camera 200 in FIG. 1, the computer 300 includes a CPU 310, an internal storage device 320 including a ROM and a RAM, an external storage device 340 including a hard disk, a display unit 370, an operation unit 380 including a mouse and a keyboard, and an interface unit 390. The interface unit 390 performs data communication with externally provided apparatuses of various types. For example, the interface unit 390 receives image data from digital camera CM.

Similarly to the external storage device 240 in FIG. 1, the external storage device 340 includes an image data storage area 342 and a reference feature data storage area 344. The external storage device 340 includes a processing table 346.

Similarly to the internal storage device 220 in FIG. 1, the internal storage device 320 stores a computer program functioning as an image processor 322. Similarly to the image processor 222 in FIG. 1, the image processor 322 includes an image analyzing unit 330, a calculation unit 336, and an information provision unit 338. Similarly to the image analyzing unit 230 in FIG. 1, the image analyzing unit 330 includes a feature data generating portion 332 and a subject identifying portion 334.

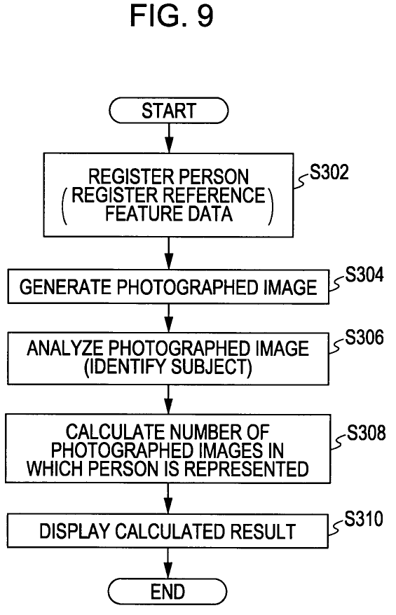

FIG. 9 is a flowchart showing a process in the third embodiment for calculating the number of representation image for each person.

In step S302, persons are registered, that is, reference feature data items are registered. Specifically, by operating the operation unit 380, an execution screen of the image processor 322 can be displayed on the display unit 370. From photographed image data items stored in the image data storage area 342 after being read from the camera CM, photographed image data items in which each person is represented are designated as registration image data items by the user. At this time, the image processor 322 uses each registration image data item to generate reference feature data item of a feature of each person. The image analyzing unit 330 stores the reference feature data item in the reference feature data storage area 344.

In step S304, in accordance with a user's instruction, the image processor 322 select a plurality of photographed images. Specifically, the user designates a plurality of photographed image data items from the photographed image data items stored in the image data storage area 342. At this time, the image processor 322 selects the photographed image data items as data items to be processed.

Similarly to step S106 (FIG. 3) in the first embodiment, in step S306, the image analyzing unit 330 identifies the subject represented in each photographed image by analyzing each of the photographed image data items selected in step S304.

Similarly to step S108 (FIG. 3) in the first embodiment, in step S308, on the basis of the result of identification in step S3076, for each person, the calculation unit 336 calculates the number of representation images in which the person is represented as a subject. On the basis of identification in step S306, for each person, the calculation unit 336 registers, in the processing table 346, data names of the representation image data items in which the person is represented as the subject.

Similarly to step S112 (FIG. 3) in the first embodiment, in step S310, the information provision unit 338 uses the processing table 346 to display a calculation result screen on the display unit 370.

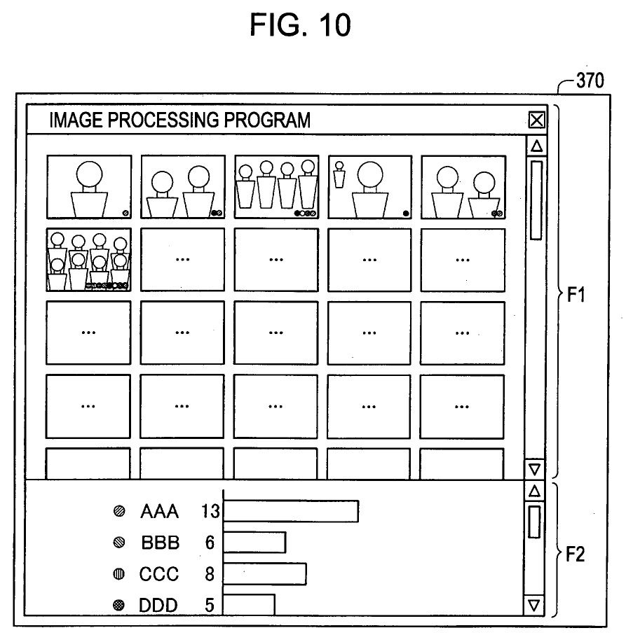

FIG. 10 is an illustration of the calculation result screen displayed on the display unit 370 in the third embodiment. As shown in FIG. 10, the execution screen of the image processor 322 includes a photographed image field F1 and a calculation result field F2.

In the photographed image field F1, the photographed images selected in step S304 are displayed. In the third embodiment, one or more circle marks are superimposed on each photographed image displayed. Each circle mark has a different color and/or pattern for each person. This allows the user to easily find photographed images in which a particular person is represented from the plurality of photographed images by referring the marks.

The calculation result field F2 shows results of calculation. Similarly to the screen in FIG. 4, in the third embodiment, for each person, a name (for example, “AAA”) and the number of representation images (for example, “13”) are displayed. The numbers of representation images are indicated by both numerical values and a bar graph. In the calculation result field F2, the circle marks in the photographed image field F1 are displayed for the persons.

The contents of the fields F1 and F2 are prepared by using the processing table 346 containing items identical to those shown in FIG. 2. Specifically, the names and numbers of representation images displayed in the calculation result field F2 are created by using the items in the “NAME” and “NUMBER OF REPRESENTATION IMAGES” columns of the processing table 346. The marks in the fields F1 and F2 are prepared by using the number of names registered in the “NAME” column of the processing table 346. Provision of the marks to the photographed images in the photographed image field F1 is performed on the basis of the data names of the representation images which are registered in the “REPRESENTATION IMAGE DATA” column of the processing table 346.

As described above, similarly to the first embodiment, also in the third embodiment, depending on the result of identifying a subject in each photographed image, for each person, the number of representation images in which the person is represented as a subject is calculated. Thus, the user can easily confirm whether the person can be represented as a subject.

Also, in the third embodiment, the first and second modifications of the first embodiment are applicable. As in the second embodiment, the number of persons may be registered.

The invention is not limited to the above-described embodiments and modifications, but can be practiced in various forms without departing from the sprit of the invention. For example, the invention can be altered as follows:

(1) In the first and second embodiments, the reference feature data items are generated and stored in a reference feature data storage area in each camera. Instead, the reference feature data items may be generated beforehand in each personal computer and may be stored in the reference feature data storage area in the camera.
(2) In the above-described embodiments, the numbers of representation images and data names of representation image data items are registered in each processing table. However, the numbers of representation images can be omitted. In this case, each calculation unit may calculate the number of representation images for each person by finding a total number of data names of representation image data items for the person. In general, depending on the result of identification, for each person, the number of representation images of the person may be calculated.

In the above-described embodiments, the data names of representation image data items are registered in the processing table. However, the data names can be omitted. If the data names of representation image data items are registered, as described above, by selecting a particular person, the user can selectively display only representation images in which the particular person is represented as a subject.

(3) In the first modification of the first embodiment, the number of portrait images is calculated. Instead of, or together with the calculated number, the number of photographed images (group photographs) in which each person is non-mainly represented may be calculated. In this case, when the number of subjects which are represented in each photographed image is not less than a predetermined number (for example, 10), and the face area sizes (the numbers of pixels) of the subjects are approximately equal, it may be determined that the photographed image is a group photograph. When the number of portrait images is calculated, the number of representation images may not be calculated.

In general, the calculation unit may calculate the number of object images in which an object is represented as a subject. The number of object images may include at least one of the number of first type object images in which the object is represented as a subject and the number of second type object images in which the object is represented as a subject in a specified form.

(4) In the above-described embodiments, a similarity is calculated by using an angular distance (expression (1)) of vectors I and O representing a feature data item and a reference feature data item. However, the similarity may be calculated by a different technique. For example, the similarity may be calculated by using a distance between two data items, specifically, by using a Euclidean distance between end points of two vectors I and O.
(5) In the above-described embodiments, the feature data item and the reference feature data item include positional data and size data. Instead thereof or together therewith, different data may be included. As the different data, for example, values of a color histogram may be included. As is well known, a color histogram is obtained by classifying the pixels of an image into a plurality of classes depending on their colors. As the different data, numerical data of shape may be included. As the numerical data of shape, for example, differential values at a plurality of points around a shape can be used.

In the above-described embodiments, the feature data item and the reference feature data item include data represented by only a numerical value. However, as the feature data item, different data can be used. For example, binary image data in which edge extracting processing is performed on a face area can also be used. In this case, by executing pattern matching using a feature data item (binary image data) and a plurality of reference feature data items (binary image data), a plurality of similarities (coincidence values) are obtained and a reference feature data item (binary image data) corresponding to the maximum similarity is selected. The subject represented in the photographed image is identified as a person corresponding to the selected reference feature data item (binary image data).

In general, the feature data item and the reference feature data item may represent a predetermined feature.

(6) In the third embodiment, the invention is realized by the personal computer 300. However, the invention may be realized by a server computer. In this case, the server communicates with a camera having a communication function and a camera connected to a cellular phone. The server receives photographed image data from the camera, and calculates, for each person, the number of representation images in which the person is represented. The server supplies the result of calculation to the camera. This can reduce processing of the camera since identifying of a subject as in the first embodiment does not need to be performed.
(7) In the above-described embodiments, a case in which objects are a plurality of persons has been described. Instead, the objects may include plural types of flowers, plural types of animals, and plural types of insects.
(8) In the above-described embodiments, the configuration, which realized by hardware, may partially be replaced by software. Conversely, the configuration, which is realized by software, may partially be replaced by hardware.

The disclosure of Japanese Patent Application No. 2006-43828 filed Feb. 21, 2006 including specification, drawings and claims is incorporated herein by reference in its entirety.

What is claimed is:

1. An image processing apparatus comprising:
a storage unit that stores a plurality of reference feature data items corresponding to a plurality of objects, the reference feature data items respectively representing predetermined features of the objects;
a feature data generating unit that, for each image of images, generates a feature data item representing one predetermined feature as a predetermined feature of a subject represented in the image;
a subject identifying unit that, for each feature data item, identifies to which of the objects the subject corresponds by using the feature data item and the reference feature data items; and
a calculation unit that, for each object, depending on a result of identifying by the subject identifying unit, calculates the number of object images in which the object is represented as the subject.

2. The image processing apparatus according to claim 1, wherein the feature data generating unit generates the feature data item of the subject when the subject satisfies predetermined subject conditions.

3. The image processing apparatus according to claim 1, wherein, for each object, depending on the result of identifying by the subject identifying unit, the calculation unit registers identification information representing an image of the object in a table.

4. The image processing apparatus according to claim 1, wherein, for each object, by using a weighting coefficient set for the object, the calculation unit calculates a first type of index value related to the number of the object images.

5. The image processing apparatus according to claim 1, wherein:
the objects are persons; and
for each object, by using a weighting coefficient set depending on a face size of the subject, the calculation unit calculates a second type of index value related to the number of the object images.

6. The image processing apparatus according to claim 1, further comprising a first notification unit that notifies a user when the number of the object images for each object does not satisfy a condition representing a predetermined number of images.

7. The image processing apparatus according to claim 1, further comprising a reference feature data generator that generates the reference feature data items stored in the storage unit.

8. The image processing apparatus according to claim 7, wherein:
the reference feature data generator includes the feature data generating unit and the subject identifying unit; and
when the subject identifying unit is unable to identify the subject by using the feature data item generated by the feature data generating unit and at least one reference feature data item stored in the storage unit, the reference feature data generator stores the feature data item as one reference feature data item in the storage unit.

9. The image processing apparatus according to claim 8, further comprising a second notification unit that notifies a user when the number of the reference feature data items stored in the storage unit is less than the number of the object images.

10. The image processing apparatus according to claim 1, wherein, after the subject identifying unit calculates a plurality of similarities by using both the feature data item and the reference feature data items, the subject identifying unit selects one of the reference feature data items which corresponds to a maximum similarity among the similarities, and identifies the subject as one of the objects which corresponds to the selected reference feature data item.

11. An image processing method using a plurality of reference feature data items corresponding to a plurality of objects, the reference feature data items respectively representing predetermined features of the objects, the image processing method comprising:
(a) for each image of images, generating a feature data item representing one predetermined feature as a predetermined feature of a subject represented in the image;
(b) for each feature data item, identifying to which of the objects the subject corresponds by using the feature data item and the reference feature data items; and
(c) for each object, depending on a result of the identifying, calculating the number of object images in which the object is represented as the subject.

12. A program Product for allowing a computer to execute an image processing method using a plurality of reference feature data items corresponding to a plurality of objects, the reference feature data items respectively representing predetermined features of the objects, the computer program allowing the computer to realize the functions of:
for each of images, generating a feature data item representing one predetermined feature as a predetermined feature of a subject represented in the image;
for each feature data item, identifying to which of the objects the subject corresponds by using the feature data item and the reference feature data items; and
for each object, depending on a result of the identifying, calculating the number of object images in which the object is represented as the subject.

13. A computer-readable recording medium containing the computer program set forth in claim 12.
